(19) United States
(12) Patent Application Publication
(10) Pub. No.: US 2004/0109929 A1
(43) Pub. Date: Jun. 10, 2004

(54) Process for producing fat

(75) Inventors: Masayuki Matsui, Tsukuba-gun (JP); Satoru Morinaga, Tsukuba-gun (JP); Koji Asama, Izumisano-shi (JP); Koreta Ueyama, Izumisano-shi (JP); Toshio Ushioda, Tsukuba-gun (JP); Masako Okochi, Tsukuba-gun (JP); Kotaro Yamaguchi, Tsukuba-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI OIL CO., LTD.

(21) Appl. No.: 10/456,630

(22) Filed: Jun. 9, 2003

(30) Foreign Application Priority Data
Dec. 6, 2002 (JP) P. 2002-355682

(51) Int. Cl. A23D 7/00

(52) U.S. Cl. 426/601

(57) ABSTRACT

A fat for producing confectionery having an improved fatty taste, which is produced by adding an aqueous solution of at least one organic acid selected from the group consisting of ascorbic acid, erythorbic acid, lactic acid, tartaric acid, citric acid and malic acid to a fat for confectionery production, followed by drying, a process for producing the fat for confectionery production, and a product, such as chocolate and/or cream, using the fat for confectionery production.

### FIELD OF THE INVENTION

The present invention relates to oil and fat (hereinafter, merely referred to as “fat”) for producing confectionery, a process for producing the fat for confectionery production, and a product using the same, and more particularly, it relates to a fat for confectionery production improved in fatty taste and a product using the same.

### BACKGROUND OF THE INVENTION

Chocolate as a representative fat based confectionery is typically produced from cacao mass, cocoa butter, sugar, powdered milk and the like. The cocoa butter is formed with a 1,3-saturated and 2-unsaturated triglyceride, such as POSt, StOSt and POP (wherein P represents palmitic acid, O represents oleic acid, and St represents stearic acid) and is present in an amount of about 32% in typical chocolate consumed as a confectionery by itself. As purposes for improving properties of chocolate and for reducing the production cost, another fat (hard butter) is often used instead of a part or the whole of the cocoa butter, and the hard butter includes those rich in a 1,3-saturated and 2-unsaturated triglyceride, which are referred to as CBE (cocoa butter equivalent), and those of lauric series or high elaidic acid type, which are referred to as CBR (cocoa butter replacer). Further, so-called white chocolate, which contains substantially no cacao component, is also available. (Hereinafter, the term “chocolate product” means any chocolate products including so-called semi-chocolate provided in the standards in Japan as not being confined by the acts and the standards of various countries.)

The recent chocolate confectioneries are not limited to chocolate consumed solely but include various products, such as a combination confectionery combined with a baked cake, a whipped chocolate and a low melting point chocolate, which is supplied in the winter season.

There are increasing occasions where the properties of chocolate are improved by using hard butter for producing such new chocolate confectioneries.

In the case where the fat content is increased by newly adding hard butter to improve the properties, in particular, there is such a tendency that fatty taste (fatty eating quality and fatty odor) is strengthened.

There is such an increasing tendency that fatty taste of fat based confectioneries and the like is disliked, which seems to be a consequence of the recent trend of increasing dietary. According to the findings by the inventors, the fatty taste is generally strengthened by increasing the fat content, and there is such a tendency that white chocolate is strengthened in fatty taste in comparison to sweet chocolate even with the same fat content.

Furthermore, there are the similar tendencies that the fatty taste of cream (which is used as a filling of a sandwich cake or a component of a milk beverage) is strengthened with the lapse of time, and is also strengthened under exposure to light or heat for a long period of time. These tendencies are conspicuous in the case where the products are sold in around-the-clock convenience stores as a recent trend.

### SUMMARY OF THE INVENTION

An object of the invention is to provide a fat for producing confectionery suitable for improving fatty taste of fat based confectioneries and milk beverages using chocolate, cream and the like.

As a result of extensive investigations by the inventors for solving the above-mentioned problems, it has been found that hard butter containing ascorbic acid, which is inherently slightly soluble in fats, largely lightens the fatty taste of a hard butter product, such as chocolate, and thus the invention has been completed.

Accordingly, the invention relates to, as one aspect, a fat for confectionery production containing at least one organic acid selected from the group consisting of ascorbic acid, erythorbic acid, lactic acid, tartaric acid, citric acid and malic acid. It is preferred that the fat contains the organic acid in an amount of from 2 to 60 ppm.

The invention also relates to, as another aspect, a process for producing a fat for confectionery production, which comprises steps of: adding a solution of at least one organic acid selected from the group consisting of ascorbic acid, erythorbic acid, lactic acid, tartaric acid, citric acid and malic acid to a fat for confectionery production or a part fat thereof, and drying the resulting mixture under heating and a reduced pressure.

The invention further relates to, as still another aspect, a product using a fat for confectionery production containing at least one organic acid selected from the group consisting of ascorbic acid, erythorbic acid, lactic acid, tartaric acid, citric acid and malic acid. The product using a fat for producing confectionery may be a chocolate product, and may be white chocolate, milk chocolate, whipped chocolate or chocolate for coating ice cream. The effect of the invention is advantageously exerted in the case where the product using a fat for producing confectionery has a fat content of 30% or more. The product using a fat for producing confectionery may be an emulsified product.

### DETAILED DESCRIPTION OF THE INVENTION

The organic acid used in the invention may be those generally used as foods and medicines, and may be used solely or in combination of two or more thereof.

The content of the organic acid is preferably 2 ppm or more in the fat for producing confectionery, and a too small content thereof provides less effect of decreasing fatty taste. The organic acid generally cannot be contained in a larger amount owing to the low solubility thereof in fats, and the content thereof is generally 60 ppm or less. Exhibition of the effect of the organic acid is insufficient in the case where it is dispersed in the fat for producing confectionery but is not dissolved, and therefore, it is preferred as described later that an aqueous solution of the organic acid is mixed with the fat, and then or during the mixing operation, water is evaporated by drying.

As the fat for producing confectionery, the known hard butter may be used in the case where it is used in a chocolate product as a food utilizing the same, and it may also be apart fat therefor (such as a middle melting point fraction of palm oil rich in POP, a fractionated oil of shea fats rich in StOSt, and StLSt fat, wherein L represents linoleic acid) or a liquid oil for adjusting the melting point or the hardness of the hard butter. The source of the fats may be a vegetable oil, such as soybean oil, rapeseed oil, corn oil, cotton seed oil, peanut oil, sunflower oil, rice oil, saffron oil, safflower oil, olive oil, sesame oil, palm oil, coconut oil and palm kernel oil, and an animal fat, such as beef tallow and lard, and it may also be a processed fat obtained by subjecting them to fractionation, hydrogenation or interesterification as occasion demands, or a combination thereof. In the case where the food using the fat for producing confectionery is a fat for cream, a fat having a melting point of 5° C. or higher is generally used.

As a preferred process for producing a fat for confectionery production containing an organic acid according to the invention, for example, in case of obtaining a fat containing an ascorbic acid, it is preferred that an ascorbic acid solution, most ordinarily an aqueous ascorbic acid solution, is added to a warmed or heated fat, and drying and removal of the solvent are carried out while stirring under conditions of a temperature of from 50 to 180° C. and a vacuum degree of from 0.5 to 100 Torr. The concentration of the ascorbic acid solution may be from 0.1 to 22%, and preferably from 1 to 10%. When the concentration is too small, the amount of the solvent, such as water, relative to the fat is increased to result in inferior production efficiency. When the concentration is too large, crystals of ascorbic acid are precipitated, which results in difficulty of incorporation into the fat. In the case where the temperature is too low, drying or removal of the solvent requires a prolonged period of time, and in the case where it is too high, ascorbic acid is decomposed to result in poor effect. A higher vacuum degree shortens the time required for drying.

Another antioxidant, such as extracted tocopherol, ascorbyl palmitate and catechin, may be used in combination with the organic acid, and the amount thereof used in this case is generally from 10 to 2,000 ppm, within which there are some cases where the effect of addition of the organic acid is enhanced. The antioxidant can be easily incorporated into a fat by simply adding to the fat and dissolving or dispersing therein, and thus an arbitrary addition method may be employed therefor.

The fat obtained by the production process according to the invention is particularly suitable for purposes where a fatty taste is liable to be recognized, and favorably exerts the effect upon adding to a food having a relatively high fat content (such as a food having a fat content of 30% or more), a fat based confectionery to be exposed to light for a long period of time (such as a fat-containing food, e.g., cream, displayed in around-the-clock convenience stores), and an emulsified product to be exposed to heat for a long period of time (such as a cream-containing beverage, typically cafe au lait, in a hot vending machine), so as to well reduce the fatty taste thereof. Examples of the food having a relatively high fat content include a chocolate product, and in general, the technique of the invention can be favorably applied to those having a fat content of from 30 to 70%, such as chocolate for coating ice cream and whipped chocolate. The effect is significantly exerted in white chocolate and milk chocolate in comparison to black (plain) chocolate and sweet chocolate with the same fat content.

The method of using the organic acid-containing fat for producing confectionery to a food using the same is not particularly limited, and in the case of a chocolate product, for example, the fat in a molten state can be mixed with other ingredients, or in alternative, can be added as an extra fat after conching. Examples of the emulsified product include an oil-in-water cream composition and a milk beverage using the same.

### EXAMPLES

The invention will be described in more detail with reference to the following examples, but the spirit of the invention are not construed as being limited thereto. In the examples, percents and parts are by weight.

Details of ascorbic acid or the like materials used in Examples and Comparative Examples will be described below.

Ascorbic Acid:

“L-Ascorbic Acid”, a trade name, manufactured by Wako Pure Chemical Industries, Ltd., purity: 99.5% Erythorbic acid:

“Erythorbic Acid”, a trade name, manufactured by Wako Pure Chemical Industries, Ltd., purity: 97.0%

Lactic Acid:

“DL-Lactic Acid”, a trade name, manufactured by Kishida Chemical Co., Ltd., total acid content: 90 to 92%

Tartaric Acid:

“DL-Tartaric Acid”, a trade name, manufactured by Kishida Chemical Co., Ltd., purity: 99%

Citric Acid:

“Citric Acid (Crystalline)”, a trade name, manufactured by Roche Vitamins Japan Co., Ltd.

Malic Acid:

“Malic Acid”, a trade name, manufactured by Wako Pure Chemical Industries, Ltd., purity: 97.0%

Tocopherol:

“E mix 80”, a trade name, manufactured by Eisai Co., Ltd.

In the following, the term “fatty taste” is a result obtained by sensory evaluation of strength of flavor characteristic in fats. Light fatty taste, as peculiar flavor of fats, does not always result in unfavorable results, but much (strong) fatty taste and deterioration (oxidation) of fats are evaluated as poor results.

### Example 1 and Comparative Examples 1 and 2

Preparation of Ascorbic Acid-Containing Hard Butter

0.2 part by weight of a 1% aqueous ascorbic acid solution was added to 100 parts by weight of hard butter (“Melano New SS7”, a trade name, manufactured by Fuji Oil Co., Ltd.) heated at 70° C., and the resulting mixture was subjected to dehydration treatment with stirring under conditions of a temperature of 70° C. and a vacuum degree of from 40 Torr for 20 minutes. The mixture was filtered with TOYO No. 5C filter paper (corresponding to 1 μm) to produce ascorbic acid-containing hard butter as a filtrate.

As Example 1, 10 parts of the ascorbic acid-containing hard butter thus produced was added to 90 parts of white chocolate (manufactured by Fuji Oil Co., Ltd., fat content: about 34%) having been separately dissolved, and the temperature of the mixture was adjusted to 31° C. A seeding agent (“Chocoseed A”, a trade name, manufactured by Fuji Oil Co., Ltd.) was added thereto in an amount of 0.2% based on the amount of the chocolate, and then a tempering treatment was carried out, followed by cooling. Thereafter, aging was carried out for 1 week to obtain white chocolate (fat content: about 41%).

As Comparative Example 1, white chocolate (fat content: about 41%) was produced in the same manner as in Example 1 except that hard butter containing no ascorbic acid (“Melano New SS7”, a trade name, manufactured by Fuji Oil Co., Ltd.) was used instead of the ascorbic acid-containing hard butter.

As Comparative Example 2, white chocolate was produced in the same manner as in Example 1 except that 10 parts of hard butter (“Melano New SS7”, a trade name, manufactured by Fuji Oil Co., Ltd.) was added to 90 parts of dissolved raw material white chocolate (manufactured by Fuji Oil Co., Ltd., fat content: about 34%), the temperature of the mixture was adjusted to 31° C., and ascorbic acid was added to the resulting mixture in an amount of 10 ppm based on the total mixture, followed by stirring and mixing for uniformity, to which the seeding agent was then added thereto.

The formulation and the evaluation results for Example 1 and Comparative Examples 1 and 2 are shown in Table 1 below.

TABLE 1

| | | Comparative | Comparative |
|---|---|---|---|
| | Example 1 | Example 1 | Example 2 |
| Ascorbic acid-containing | 10 | | |
| hard butter | | | |
| Hard butter containing no | | 10 | 10 |
| ascorbic acid | | | |
| Ascorbic acid | | | 10 ppm* |
| (added as powder) | | | |
| White chocolate | 90 | 90 | 90 |
| Seeding agent | 0.2 | 0.2 | 0.2 |
| Fatty taste | weak | strong | strong |

Note:
*10 ppm based on the total amount of 10 parts of hard butter and 90 parts of white chocolate

Example 1 and Comparative Examples 1 and 2 were compared in flavor (odor (smell) and taste) immediately after the aging, and Comparative Examples 1 and 2 were strong in fatty taste in comparison to Example 1.

The white chocolates were then stored at room temperature (about 20° C.) under fluorescent lamps with a distance of 30 cm for 1 week and then evaluated for flavor. As a result, Comparative Examples 1 and 2 were strong in fatty taste in comparison to Example 1, and the difference in fatty taste between them was larger than that before the aging.

Consequently, it has been clarified that ascorbic acid contributes to lightening of fatty taste in the case where it is added in the method used in Example 1 to provide weaker fatty taste than that before the addition thereof. It has been also clarified that the effect of decreasing fatty taste is not exerted in the case where ascorbic acid is added in the form of powder to hard butter.

### Example 2 and Comparative Example 3

Chocolate products of Example 2 and Comparative Example 3 were produced in the same manner as in Example 1 and Comparative Example 1 except that milk chocolate (manufactured by Fuji Oil Co., Ltd., fat content: about 34%) was used instead of the white chocolate. The resulting chocolate products were evaluated, and the similar results as in Example 1 and Comparative Example 1 were obtained.

### Example 3 and Comparative Example 4

As Example 3, 10 parts of the ascorbic acid-containing hard butter thus produced in Example 1 was added to 90 parts of dissolved sweet chocolate (manufactured by Fuji Oil Co., Ltd., fat content: about 34%), and a tempering treatment was carried out at a minimum temperature of 26° C. and a reheating point of 28° C., followed by cooling, to obtain sweet chocolate (fat content: about 41%).

As Comparative Example 4, sweet chocolate was produced in the same manner as in Example 3 except that hard butter containing no ascorbic acid (“Melano New SS7”, a trade name, manufactured by Fuji Oil Co., Ltd.) was used instead of the ascorbic acid-containing hard butter. The sweet chocolate thus obtained had strong fatty taste in comparison to the product of Example 3 immediately after the aging, and the difference in fatty taste between them was increased after storing at room temperature (about 20° C.) under fluorescent lamps with a distance of 30 cm for 1 week. The differences between the products of Examples 1 and 2 and the comparative products were larger than the difference between the products of Example 3 and Comparative Example 4.

The formulation and the evaluation results for Example 2 and Comparative Example 3, and Example 3 and Comparative Example 4 are shown in Table 2 below.

TABLE 2

| | | Comparative | | Comparative |
|---|---|---|---|---|
| | Example 2 | Example 3 | Example 3 | Example 4 |
| Ascorbic acid- | 10 | | 10 | |
| containing hard | | | | |
| butter | | | | |
| Hard butter | | 10 | | 10 |
| containing no | | | | |
| ascorbic acid | | | | |
| Milk chocolate | 90 | 90 | | |
| Sweet chocolate | | | 90 | 90 |
| Seeding agent | 0.2 | 0.2 | 0.2 | 0.2 |
| Fatty taste | weak | strong | weak | strong |

The evaluation in fatty taste cannot be carried out between chocolate products having different flavor or different taste. Therefore, the results obtained herein were relative evaluation between Example 2 and Comparative Example 3 and that between Example 3 and Comparative Example 4. The difference between Example 2 and Comparative Example 3 was larger than the difference between Example 3 and Comparative Example 4.

### Example 4 and Comparative Example 5

As Example 4, 28 parts of whole milk powder, 44 parts of sugar, 22 parts of the ascorbic acid-containing hard butter produced in the same manner as in Example 1 and a small amount of lecithin were mixed and refined with rolls, and 6 parts of the ascorbic acid-containing hard butter was then further added, followed by subjecting to conching, to obtain a white chocolate base (fat content: about 41%). After adjusting the temperature thereof to 31° C., a white chocolate product was obtained in the same manner as in Example 1.

As Comparative Example 5, a white chocolate product was produced in the same manner as in Example 4 except that hart butter containing no ascorbic acid was used instead of the ascorbic acid-containing hard butter. The resulting product had strong fatty taste in comparison to the product of Example 4, which was the similar result as in Examples 1 and 2.

The formulations and the evaluations results in Example 4 and Comparative Example 5 are shown in Table 3 below.

TABLE 3

| | | Comparative |
|---|---|---|
| | Example 4 | Example 5 |
| Whole milk powder | 28 | 28 |
| Sugar | 44 | 44 |
| Ascorbic acid-containing hard butter | 22 | |
| Hard butter containing no ascorbic acid | | 22 |
| Lecithin | small amount | small amount |
| Seeding agent | 0.2 | 0.2 |
| Fatty taste | weak | strong |

The chocolates produced in Examples 1 to 4 and Comparative Examples 1 to 5 were evaluated in eating quality and flavor with five panelists, and the chocolates of Example 1 to 4 had less fatty taste owing to the use of the ascorbic acid-containing hard butter. This was a particular feature that had not been found in the conventional chocolate produced with hard butter containing no ascorbic acid. The feature was conspicuous particularly in chocolates containing a milk solid content, such as white chocolate and milk chocolate.

On the other hand, the products of Comparative Examples 1 to 5 also failed to provide such a feature.

### Example 5

As Example 5, 80 parts of dissolved milk chocolate (manufactured by Fuji Oil Co., Ltd., fat content: about 34%), 10 parts of hard butter (“Melano New SS7”, a trade name, manufactured by Fuji Oil Co., Ltd.), 10 parts of the ascorbic acid-containing hard butter produced in Example 1 and 1 part of propylene glycol stearic acid ester (“Rikemal PS100, a trade name, manufactured by Riken Vitamin Co., Ltd.) were mixed, and the temperature of the mixture was adjusted to 31° C. A seeding agent (“Chocoseed A”, a trade name, manufactured by Fuji Oil Co., Ltd.) was added thereto in an amount of 0.2% based on the amount of the chocolate, and then a tempering treatment was carried out, followed by decreasing the temperature to 25° C. The chocolate thus obtained was whipped by agitating in Kenwood Mixer (using a whipper) at a middle speed to obtain whipped chocolate. The whipped chocolate had a specific gravity of about 0.6.

As comparative Example 6, whipped chocolate having a specific gravity of about 0.6 was produced in the same formulation and the same manner as in Example 5 except that 20 parts of hard butter containing no ascorbic acid (“Melano New SS7”, a trade name, manufactured by Fuji Oil Co., Ltd.) was used instead of the ascorbic acid-containing hard butter.

### Example 6

Hard butter and white chocolate were produced in the same formulation and the same manner as in Example 1 except that erythorbic acid was used instead of ascorbic acid.

### Example 7

Hard butter and white chocolate were produced in the same formulation and the same manner as in Example 1 except that malic acid was used instead of ascorbic acid.

### Example 8

Hard butter and white chocolate were produced in the same formulation and the same manner as in Example 1 except that lactic acid was used instead of ascorbic acid.

### Example 9

Hard butter and white chocolate were produced in the same formulation and the same manner as in Example 1 except that tartaric acid was used instead of ascorbic acid.

### Example 10

Hard butter and white chocolate were produced in the same formulation and the same manner as in Example 1 except that citric acid was used instead of ascorbic acid.

The chocolates thus produced were evaluated in eating quality and flavor with five panelists, and the chocolates of Example 5 to 10 had less fatty taste in comparison to the product of Comparative Example 6.

The formulations and the evaluations of Examples 5 to 10 and Comparative Example 6 are shown in Table 4 below.

TABLE 4

| | | Comparative | | |
|---|---|---|---|---|
| | Example 6 | Example 1 | Example 7 | Example 8 |
| Erythorbic | 10 | | | |
| acid-containing hard | | | | |
| butter | | | | |
| Malic acid- | | | 10 | |
| containing hard butter | | | | |
| Lactic acid- | | | | 10 |
| containing hard butter | | | | |
| Hard butter | | 10 | | |
| containing | | | | |
| no ascorbic acid | | | | |
| White chocolate | 90 | 90 | 90 | 90 |
| Seeding agent | 0.2 | 0.2 | 0.2 | 0.2 |
| Fatty taste | weak | strong | weak | weak |

| | | | Comparative |
|---|---|---|---|
| | Example 9 | Example 10 | Example 1 |
| Tartaric acid-containing | 10 | | |
| hard butter | | | |
| Citric acid-containing hard | | 10 | |
| butter | | | |
| Hard butter containing no | | | 10 |
| ascorbic acid | | | |
| White chocolate | 90 | 90 | 90 |
| Seeding agent | 0.2 | 0.2 | 0.2 |
| Fatty taste | weak | weak | strong |

### Examples 11 to 13

White chocolates were produced in the same formulation and the same manner as in Example 1 and Comparative Example 1 except that hard butter having an ascorbic acid content of 12 ppm, 6 ppm or 3 ppm was used. The ascorbic acid contents in the hard butter were 12 ppm, 6 ppm and 3 ppm in Examples 11, 12 and 13, respectively.

The products thus obtained were evaluated as compared with Comparative Example 1. As a result, the fatty taste of the product of an ascorbic acid content of 3 ppm was improved in comparison to Comparative Example 1, and the effect was largely exerted in the cases where the ascorbic acid content was larger, i.e., the products having ascorbic acid contents of 6 ppm and 12 ppm exerted more conspicuous effect in lightening the fatty taste in this order.

The formulations and the evaluation results of Examples 11 to 13 and Comparative Example 1 were shown in Table 5 below.

TABLE 5

| | | | | Comparative |
|---|---|---|---|---|
| | Example 11 | Example 12 | Example 13 | Example 1 |
| Ascorbic | 10 | | | |
| acid-containing | | | | |
| hard butter | | | | |
| (12 ppm) | | | | |
| Ascorbic | | 10 | | |
| acid-containing | | | | |
| hard butter | | | | |
| (6 ppm) | | | | |
| Ascorbic | | | 10 | |
| acid-containing | | | | |
| hard butter | | | | |
| (3 ppm) | | | | |
| Hard butter | | 10 | | 10 |
| containing no | | | | |
| ascorbic acid | | | | |
| White | 90 | 90 | 90 | 90 |
| chocolate | | | | |
| Seeding agent | 0.2 | 0.2 | 0.2 | 0.2 |
| Fatty taste | weak | weak | weak | strong |

While all the evaluations of fatty taste in Examples 11 to 13 were “weak”, the relative evaluation results thereof were schematically as follows. Weak fatty taste . . . Example 11<Example 12<Example 13<<Comparative Example 1 . . . Strong fatty taste

### Examples 14 to 16

White chocolates were produced in the same formulation and the same manner as in Example 1 and Comparative Example 1 except that hard butter having a malic acid content of 60 ppm, 20 ppm or 10 ppm was used. (The malic acid contents in the hard butter were 60 ppm, 20 ppm and 10 ppm in Examples 14, 15 and 16, respectively.)

The products thus obtained were evaluated as compared with Comparative Example 1. As a result, the fatty taste of the product of a malic acid content of 10 ppm was improved in comparison to Comparative Example 1, and the effect was largely exerted in the cases where the malic acid content was larger, i.e., the products having malic acid contents of 20 ppm and 60 ppm exerted more conspicuous effect in lightening the fatty taste in this order.

The formulations and the evaluation results of Examples 14 to 16 and Comparative Example 1 were shown in Table 6 below.

TABLE 6

| | | | | Comparative |
|---|---|---|---|---|
| | Example 14 | Example 15 | Example 16 | Example 1 |
| Malic acid- | 10 | | | |
| containing | | | | |
| hard butter | | | | |
| (60 ppm) | | | | |
| Malic acid- | | 10 | | |
| containing | | | | |
| hard butter | | | | |
| (20 ppm) | | | | |
| Malic acid- | | | 10 | |
| containing | | | | |
| hard butter | | | | |
| (10 ppm) | | | | |
| Hard butter | | | | 10 |
| containing | | | | |
| no ascorbic | | | | |
| acid | | | | |
| White | 90 | 90 | 90 | 90 |
| chocolate | | | | |
| Seeding agent | 0.2 | 0.2 | 0.2 | 0.2 |
| Fatty taste | weak | weak | weak | strong |

While all the evaluations of fatty taste in Examples 14 to 16 were “weak”, the relative evaluation results thereof were schematically as follows.

Weak fatty taste . . . Example 14<Example 15<Example 16<<Comparative Example 1 . . . Strong fatty taste

### Example 17

Ascorbic acid-containing hard butter (A) was prepared in the following manner. 0.2 part by weight of a 1% aqueous ascorbic acid solution was added to 100 parts by weight of a fat for producing confectionery (hardened oil having an ascending melting point of 22° C., which was a purified oil produced from rapeseed) heated at 70° C., and the resulting mixture was subjected to dehydration treatment with stirring under conditions of a temperature of 70° C. and a vacuum degree of from 40 Torr for 20 minutes. The mixture was filtered with TOYO No. 5C filter paper (corresponding to 1 μm) to produce an ascorbic acid-containing fat for confectionery production (A) as a filtrate.

An oil-in-water emulsified product (B) was produced with a formulation of 35% of the thus-obtained ascorbic acid-containing fat for producing confectionery, 2% of sodium caseinate, 0.3% of lysolecithin, 0.5% of polyglycerin fatty acid ester, 0.2% of sucrose fatty acid ester, 0.1% of sodium metaphosphate and 61.9% of water, in the following manner. That is, the formulation was preliminarily emulsified at 70° C. for 30 minutes, and then uniformized in a two-stage homogenizer at 0 MPa for the upper stage and 10 MPa for the lower stage. Thereafter, the emulsified product was sterilized in a high-temperature direct flash steam sterilizer at 150° C. for 4 seconds, and after further uniformizing in a two-stage homogenizer at 0 MPa for the upper stage and 10 MPa for the lower stage, the temperature was quickly lowered to 5C to obtain the desired oil-in-water emulsified product (B).

A sterilized coffee beverage (C) was produced with a formulation of 2% of the oil-in-water emulsified product, 60% of a coffee extract (coffee extract of Bx 1.8°), 5% of sugar, 0.05% of sucrose fatty acid ester (“Ester P-1670”, a trade name, manufactured by Mitsubishi-Kagaku Foods Corp.) and 32.95% of water, in the following manner. The formulation was preliminarily emulsified at 60° C. for 10 minutes, and after adjusting the pH to 6.2 with sodium bicarbonate, it was uniformized in a two-stage homogenizer at 0 MPa for the upper stage and 20 MPa for the lower stage. Thereafter, the emulsified product was packed in a 190-mL can, and the canned beverage was subjected sterilization in a hot water retort sterilizer at 121° C. for 30 minutes, followed by standing to cool.

The canned beverage (C) was opened and subjected to sensory evaluation for flavor deterioration by monitoring with 10 panelists immediately after the sterilization, after allowing to stand at 5C for 14 days, after allowing to stand at 20° C. for 14 days, or after allowing to stand at 60° C. for 14 days, and the results shown in Table 7 below were obtained. The term “flavor deterioration” herein means that fatty taste is increased to cause unpleasant feeling. The profiles of the favorable evaluations include no fatty feeling, refreshing taste and quaffable taste. The evaluations of the beverage (C) are shown in Table 7.

TABLE 7
Results of Monitoring

| | |
|---|---|
| | Comparative |
| Example 17 | Example 7 |
| (C) | (F) |

Flavour deterioration*

| | yes | no | yes | no |
|---|---|---|---|---|
| Immediately after sterilization | 0 | 10 | 7 | 3 |
| after 14 days at 5° C. | 0 | 10 | 8 | 2 |
| after 14 days at 20° C. | 1 | 9 | 8 | 2 |
| after 14 days at 60° C. | 1 | 9 | 10 | 0 |

Note:
*yes: flavor deterioration was sensed.
no: flavor deterioration was not sensed.

### Comparative Example 7

An oil-in-water emulsified product (E) and a sterilized coffee beverage (F) were produced in the same manner as in the Example except that a fat containing no ascorbic acid (hardeneded oil having an ascending melting point of 22° C., which was a purified oil produced from rapeseed) (D) was used instead of the above ascorbic acid-containing fat (A).

The canned beverage (F) was opened and subjected to sensory evaluation for flavor deterioration by monitoring with 10 panelists immediately after the sterilization, after allowing to stand at 5° C. for 14 days, after allowing to stand at 20° C. for 14 days, or after allowing to stand at 60° C. for 14 days. As a result, flavor deterioration in comparison to the Example was sensed by 7 panelists immediately after the sterilization, flavor deterioration in comparison to the Example was sensed by 8 panelists after lapsing 14 days at 5° C., flavor deterioration in comparison to the Example was sensed by 8 panelists after lapsing 14 days at 20° C., and flavor deterioration in comparison to the Example was sensed by 10 subject after lapsing 14 days at 60° C. The profiles of the unfavorable evaluations includes greasy feeling, fatty feeling, heavy and bad taste remaining in mouth, and bad aftertaste, as compared to the product of the invention.

### Comparative Example 8

To the oil-in-water emulsified product (E) in Comparative Example 6 was added ascorbic acid in such an amount that corresponds to the amount of ascorbic acid contained in the ascorbic acid-containing fat for confectionery production (A) in Example 8. The product thus obtained was subjected to the same procedures and the same evaluation as in Comparative Example 6.

The results obtained were the same as in Comparative Example 6.

According to the present invention, the fatty taste of a fat for producing confectionery is improved, and a fat for producing confectionery can be provided which improves the fatty taste of a food using a fat for producing confectionery, such as chocolate.

While the invention has been described in detail and with reference to specific examples thereof, it will be apparent to one skilled in the art that various changes and modifications can be made therein without departing from the spirit and scope thereof.

What is claimed is:

1. A fat for producing confectionery which comprises at least one organic acid selected from the group consisting of ascorbic acid, erythorbic acid, lactic acid, tartaric acid, citric acid and malic acid.

2. A fat for producing confectionery as claimed in claim 1, wherein the organic acid is contained in an amount of from 2 to 60 ppm.

3. A fat for producing confectionery as claimed in claim 1, wherein the fat is hard butter.

4. A process for producing a fat for confectionery production, which comprises steps of: adding a solution of at least one organic acid selected from the group consisting of ascorbic acid, erythorbic acid, lactic acid, tartaric acid, citric acid and malic acid to a fat for confectionery production or a part fat thereof, and drying the resulting mixture under heating and a reduced pressure.

5. A process for producing a fat for confectionery production as claimed in claim 4, wherein the organic acid is contained in an amount of from 2 to 60 ppm.

6. A process for producing a fat for confectionery production as claimed in claim 4, wherein the drying and removal of the solvent are carried out while stirring under conditions of a temperature of from 50 to 180° C. and a vacuum degree of from 0.5 to 100 Torr.

7. A process for producing a fat for confectionery production as claimed in claim 4, wherein the fat is hard butter.

8. A product using a fat for confectionery production comprising at least one organic acid selected from the group consisting of ascorbic acid, erythorbic acid, lactic acid, tartaric acid, citric acid and malic acid.

9. A product using a fat for confectionery production as claimed in claim 4, wherein the product using a fat for confectionery production is chocolate.

10. A product using a fat for confectionery production as claimed in claim 4, wherein the product using a fat for confectionery production is white chocolate or milk chocolate.

11. A product using a fat for confectionery production as claimed in claim 4, wherein the product using a fat for confectionery production has a fat content of 30% or more.

12. A product using a fat for confectionery production as claimed in claim 4, wherein the product using a fat for confectionery production is whipped chocolate or chocolate for coating ice cream.

13. A product using a fat for confectionery production as claimed in claim 4, wherein the product using a fat for confectionery production is an emulsified product.
